(19) United States
(12) Patent Application Publication
(10) Pub. No.: US 2012/0225763 A1
(43) Pub. Date: Sep. 6, 2012

(54) BAG-MAKING PACKAGING MACHINE

(75) Inventors: Takafumi SHIMODA, Ritto (JP); Makoto ICHIKAWA, Ritto (JP); Masashi KONDO, Ritto (JP)

(73) Assignee: ISHIDA CO., LTD., Kyoto (JP)

(21) Appl. No.: 13/408,501

(22) Filed: Feb. 29, 2012

(30) Foreign Application Priority Data
Mar. 2, 2011 (JP) 2011-044878

(51) Int. Cl. B31B 1/26

(52) U.S. Cl. 493/243

(57) ABSTRACT

A bag-making packaging machine has a cylindrical part and a forming collar. The forming collar guides a sheet-shaped packaging material so that the packaging material wraps around the cylindrical part. The forming collar has a folded-back portion for changing a direction in which the packaging material advances to an approximately perpendicular direction. A cutout through which the thick-layered portion of the packaging material passes is formed in the folded-back portion. This reduces the amount of friction applied to the thick-layered portion when the packaging material passes by the folded-back portion of the forming collar.

### TECHNICAL FIELD

The present invention relates to a bag-making packaging machine utilizing a packaging material having a thick-layered portion.

### BACKGROUND ART

Conventionally, there are bag-making packaging machines having a cylindrical part and a forming collar for guiding a sheet-shaped packaging material so that the packaging material wraps around the cylindrical part. Such a bag-making packaging machine may use a packaging material having a thick-layered portion. For instance, the bag-making packaging machine described in Unexamined Japanese Patent Application Publication No. 2010-184732 uses a packaging material having a hem seal region. The hem seal region of Japanese Patent Unexamined Publication No. 2010-184732 is formed by partially folding over a single sheet of single-layered film and heat sealing the folded-over portion. Thus, the hem seal region is thicker than the other portions. In Japanese Patent Unexamined Publication No. 2009-46139, a single sheet of single-layered film is partially overlapped with tape. The portion where the film and tape overlaps is thicker than the other portions. In the bag-making packaging machines of Japanese Patent Unexamined Publication No. 2010-184732 and Japanese Patent Unexamined Publication No. 2009-46139, a sheet-shaped packaging material having such a thick-layered portion is subsequently conveyed along a forming collar so as to wrap around a cylindrical part.

### SUMMARY

### Technical Problem

However, when the packaging material partially has a thick-layered portion, smooth conveyance of the packaging material is impeded, and there is a risk of the packaging material being damaged. In particular, such risk increases at the folded-back portion of the forming collar, which abruptly alters the direction in which the packaging material advances. As a result, there is a possibility that, for instance, a hem seal region formed upstream from the folded-back portion of the forming collar will be damaged. In cases where a film and a tape are heat sealed upstream from the folded-back portion of the forming collar, there is also the possibility of the heat seal coming apart.

An object of the present invention is to provide a bag-making packaging machine wherein damage to a packaging material having a thick-layered portion can be prevented.

### Solution to Problem

A bag-making packaging machine according to a first aspect of the present invention has a tube part and a forming collar. The forming collar includes a fold-back portion defining a cutout. The forming collar is configured to receive a sheet-shaped packaging material that moves toward the forming collar in a first direction. The fold-back portion is configured and shaped to guide the sheet-shaped packaging material to move in a second direction perpendicular to the first direction such that the packaging material wraps around the tube part and continues to move along the tube part in the second direction. The cutout is provided along a surface of the fold-back portion such that a thick-layered portion of the sheet-shaped packaging material passes there along.

This cutout is formed on the folded-back portion of the forming collar so that the thick-layered portion of the packaging material can easily pass through. This reduces the amount of friction applied to the thick-layered portion when the packaging material passes by the folded-back portion of the forming collar. Thus, it is possible to prevent damage to the packaging material having the thick-layered portion.

A bag-making packaging machine according to a second aspect of the present invention is the bag-making packaging machine according to the first aspect, wherein the thick-layered portion extends in the direction in which the packaging material advances. A state where the thick-layered portion extends in the direction in which the packaging material advances is a state, for instance, that the thick-layered portion is continuously and uninterruptedly formed along the entirety of the packaging material in the direction in which the packaging material advances.

The presence of the cutout reduces the friction applied to the thick-layered portion extending in the direction in which the packaging material advances.

A bag-making packaging machine according to a third aspect of the present invention is the bag-making packaging machine according to the second aspect, wherein the thick-layered portion includes a hem seal region in the packaging material.

In this case, a cutout is formed on the folded-back portion of the forming collar so that the hem seal region can easily pass through. This reduces the amount of friction applied to the hem seal region when the packaging material passes by the folded-back portion of the forming collar. Thus, it is possible to prevent damage to the packaging material having a hem seal region.

A bag-making packaging machine according to a fourth aspect of the present invention is the bag-making packaging machine according to the third aspect, wherein four cutouts are formed on the folded-back portion corresponding to four hem seal regions of the packaging material.

In this machine, the four cutouts are formed on the folded-back portion of the forming collar so that the four hem seal regions can easily pass through. This reduces the friction applied to the four hem seal regions.

A bag-making packaging machine according to a fifth aspect of the present invention is the bag-making packaging machine according to the second aspect, wherein the packaging material has a main packaging material and a tape. The tape overlaps the main packaging material and is conveyed along with the main packaging material. The thick-layered portion is the portion where the main packaging material and the tape overlap. A state where the main packaging material and the tape overlap includes both a state in which the main packaging material and the tape are joined by heat sealing and a state in which the main packaging material and the tape are not been joined by heat sealing.

In this case, a cutout is formed on the folded-back portion of the forming collar so as to allow the tape being conveyed along with the main packaging material to easily pass through. This reduces the friction applied to the tape when the packaging material passes by the folded-back portion of the forming collar. Thus, damage to the packaging material having the tape extending in the direction in which the packaging material advances can be prevented.

A bag-making packaging machine according to a sixth aspect of the present invention is the bag-making packaging machine according to the fifth aspect, wherein one cutout is formed on the folded-back portion so as to correspond to the overlapping portion.

In this case, one cutout is formed in one location on the folded-back portion of the forming collar so that a strand of tape can easily pass through. This reduces the friction applied to the strand of tape.

A bag-making packaging machine according to a seventh aspect of the present invention is the bag-making packaging machine according to any of the first through the sixth aspects, wherein the forming collar is positioned so that there is formed, between the forming collar and the cylindrical part, a gap into which the packaging material is inserted. A space defined by the cutout is a part of this gap.

In this case, the friction applied to the thick-layered portion of the packaging material as it proceeds into the narrow gap between the cylindrical part and the forming collar is reduced.

### Advantageous Effects of Invention

In the present invention, a cutout is formed on the folded-back portion of the forming collar so that the thick-layered portion of the packaging material can easily pass through. This reduces the amount of friction applied to the thick-layered portion when the packaging material passes by the folded-back portion of the forming collar. Thus, it is possible to prevent damage to the packaging material having the thick-layered portion.

### BRIEF DESCRIPTION OF THE DRAWINGS

FIG. 1 is a perspective view of a bag-making packaging machine according to a first embodiment of the present invention;

FIG. 2 is a side view of the bag-making packaging machine;

FIG. 3 is a perspective view of a bag-making packaging unit;

FIG. 4 is a perspective illustration of the bag-making packaging unit and a film supply unit;

FIG. 5 is an illustration of a gusseted bag;

FIG. 6 is a control block diagram for the bag-making packaging machine;

FIG. 7 is an illustration of a hem forming mechanism;

FIG. 8A is a view of an bottom side of a film at the time that it arrives at a forming collar;

FIG. 8B is a cross-sectional view along line VIIIB-VIIIB in FIG. 8A;

FIG. 9A is a left rear perspective view of the vicinity of a folded-back portion of the forming collar;

FIG. 9B is a right rear perspective view of the vicinity of a folded-back portion of the forming collar;

FIG. 9C is a cross-sectional top view of the folded-back portion of the forming collar;

FIG. 10A is a top view of a crimper pressed against a square tubular film;

FIG. 10B is a front view of the crimper pressed against the square tubular film;

FIG. 11A is an illustration of a bottom forming mechanism being driven;

FIG. 11B is another illustration of the bottom forming mechanism being driven;

FIG. 12 is an illustration of a sealing jaw being driven;

FIG. 13 is a perspective view of a bag-making packaging machine according to a second embodiment of the present invention;

FIG. 14 is an illustration of a pillow bag;

FIG. 15 is a side view of the bag-making packaging machine;

FIG. 16 is a perspective view of a bag-making packaging unit;

FIG. 17 is a control block diagram for the bag-making packaging machine;

FIG. 18 is a top view of a film when arriving at a forming collar;

FIG. 19 is a left rear perspective view of the vicinity of a folded-back portion of the forming collar;

FIG. 20 is a perspective view of a spreader mechanism and a tube;

FIG. 21 is a perspective view of a supporter;

FIG. 22 is a perspective view of the tube;

FIG. 23 is a cross-sectional view of the spreader mechanism and the tube;

### DETAILED DESCRIPTION

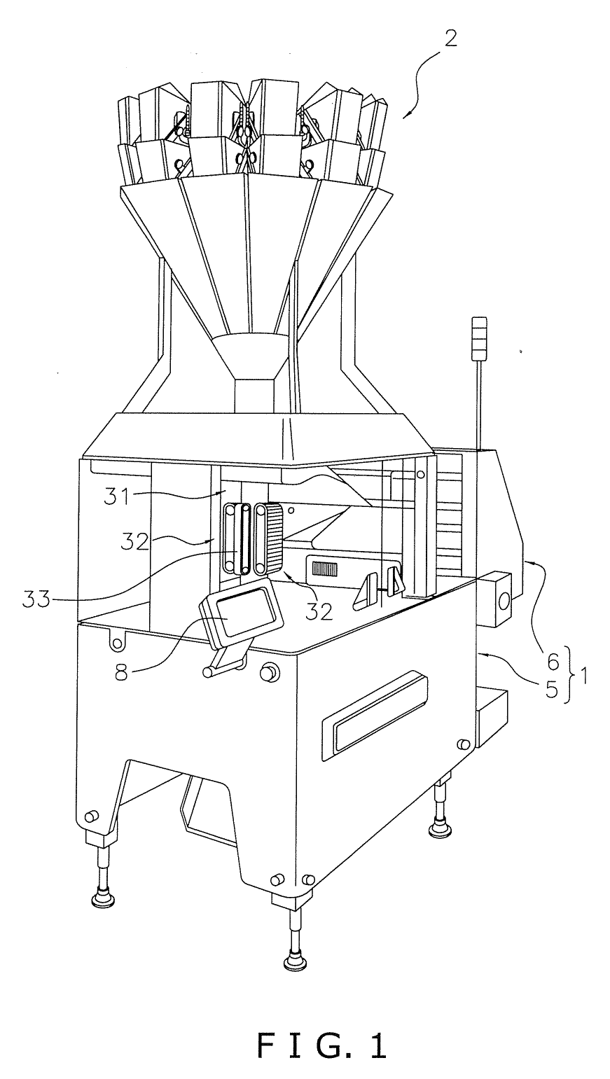

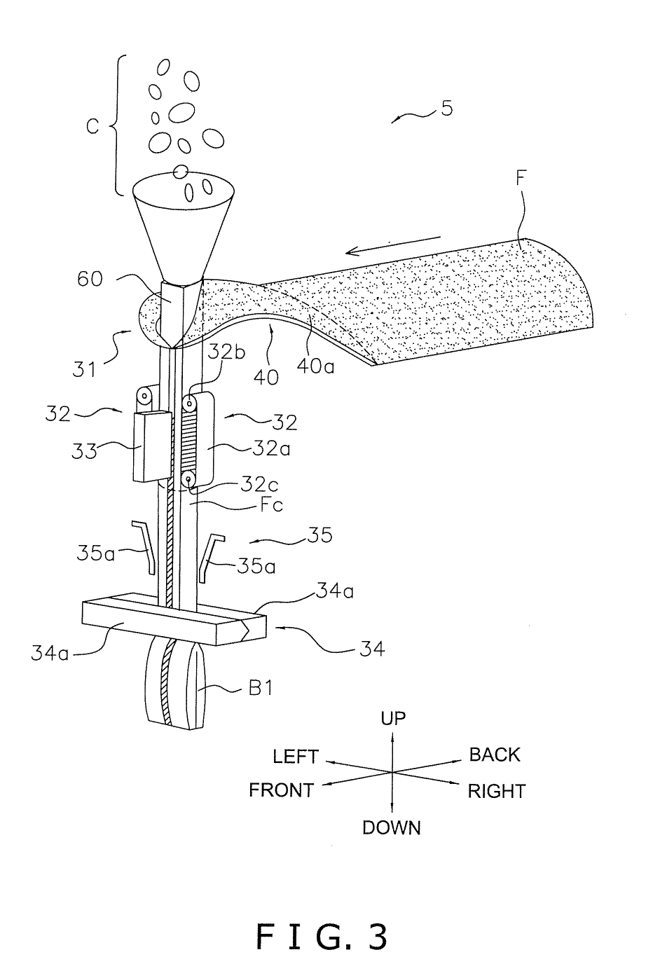

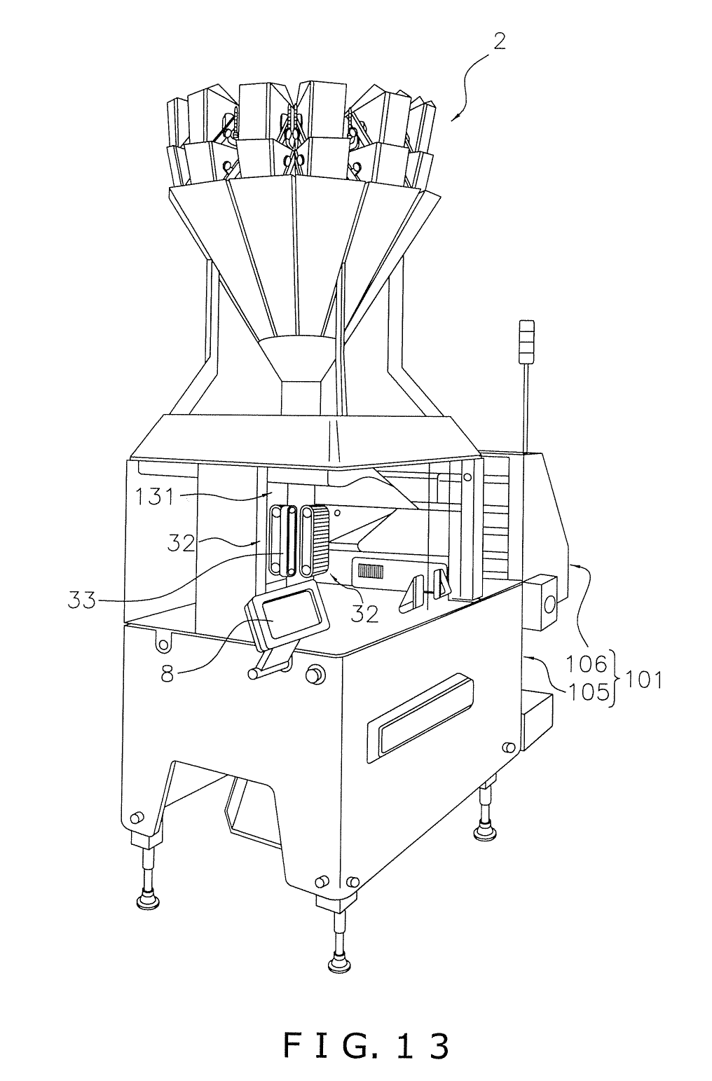

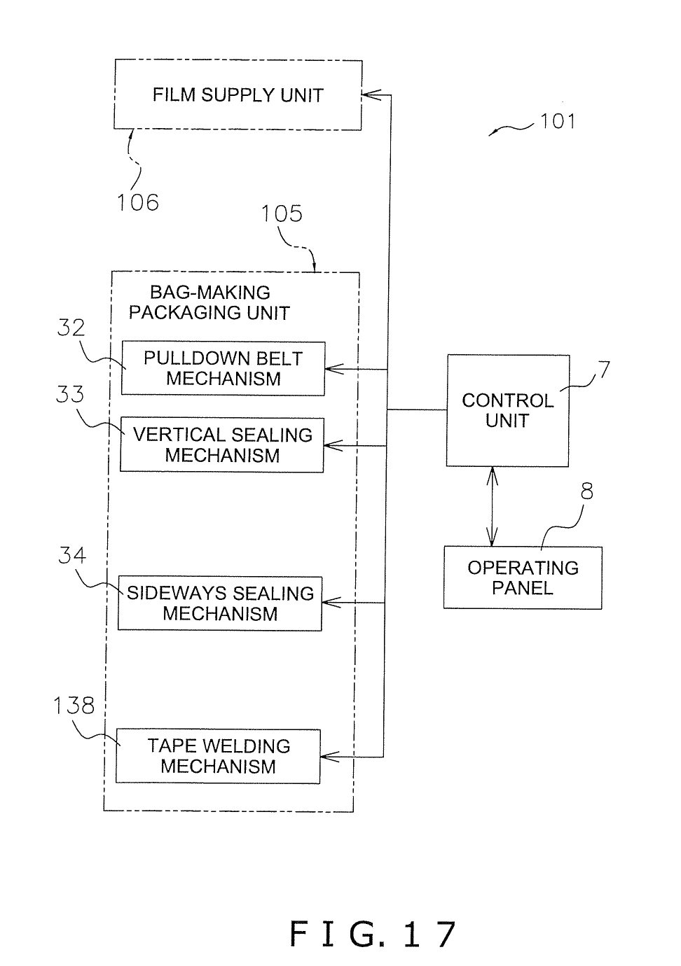

A bag-making packaging machine 1 according to a first embodiment (FIGS. 1-12) and a bag-making packaging machine 101 according to a second embodiment (FIGS. 13-23) will be explained hereafter with reference to the drawings. In describing the bag-making packaging machines 1 and 101, the terms “front,” “rear,” “up,” “down,” “left,” and “right” shall be defined as shown in FIG. 3. “Upstream” and “downstream” shall be based on the direction in which a film F is conveyed.

### (1) First Embodiment

(1-1) Overall Configuration

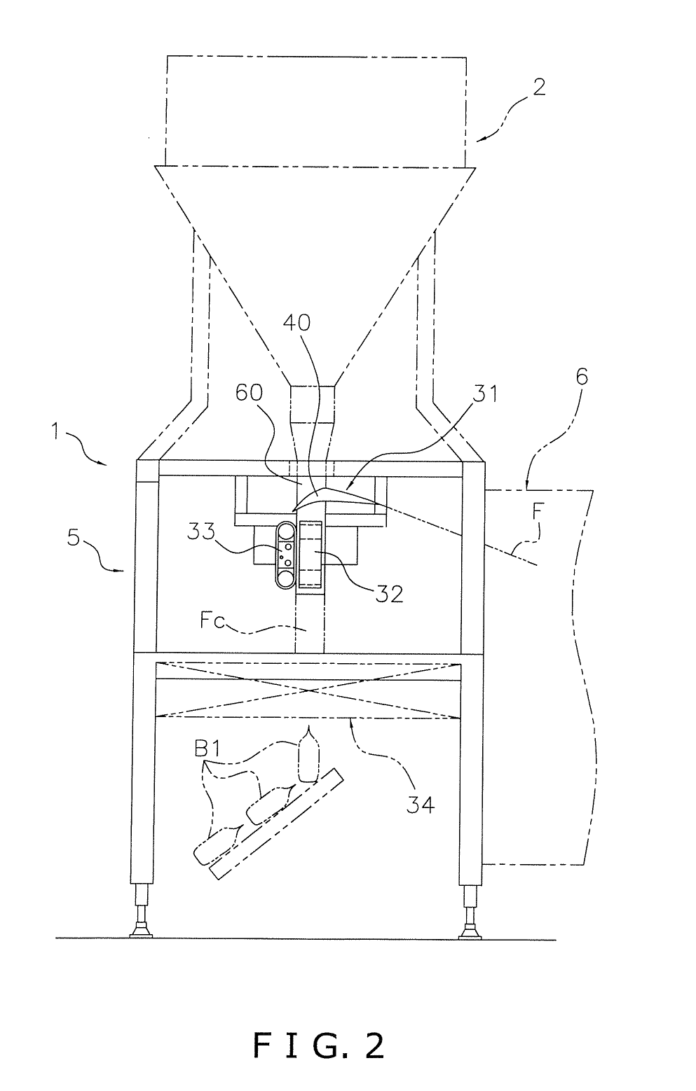

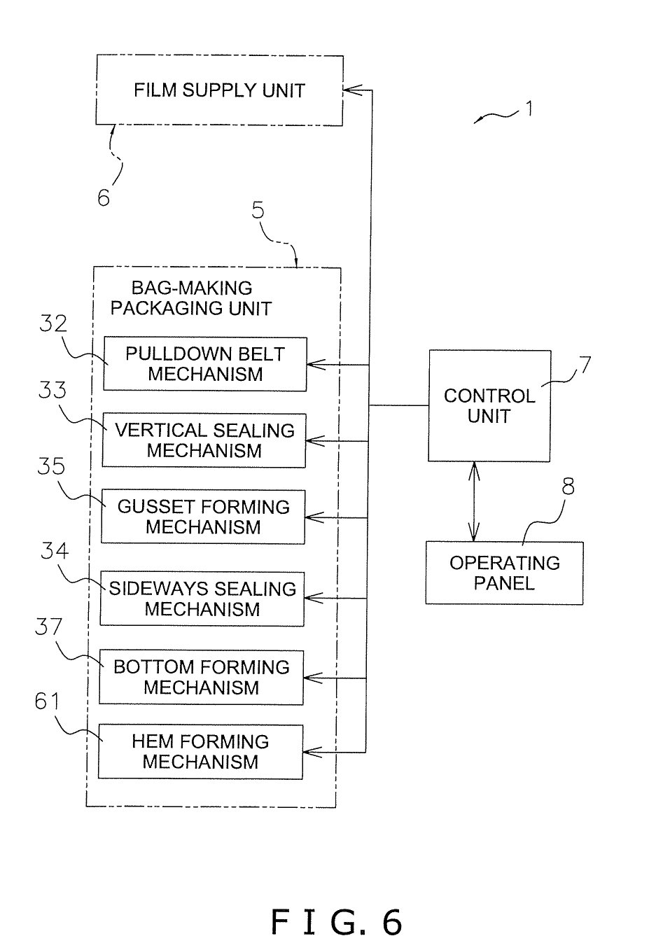

The bag-making packaging machine 1 according to the first embodiment shown in FIGS. 1 and 2, is a machine for manufacturing a product bagged articles C (see FIG. 3) such as a snack food. As shown in FIGS. 1 and 2, the bag-making packaging machine 1 has a bag-making packaging unit 5 for bagging the articles C, a film supply unit 6 for supplying a film F used as a material for part of a product bag B1 (FIG. 2) to the bag-making packaging unit 5, and a control unit 7 for controlling the overall operation of the bag-making packaging machine 1 (see FIG. 6). The articles C bagged by the bag-making packaging unit 5 is weighed by a combination weigher 2 disposed above the bag-making packaging unit 5. The bag-making packaging unit 5 bags the articles C in harmony with the timing with which the articles C is supplied from the combination weigher 2.

An operating panel 8 is disposed on the front of the bag-making packaging unit 5 facing to the right. The operating panel 8 has an LCD and a touchscreen that covers the LCD. The operating panel 8 displays information showing the operating status of the bag-making packaging machine 1 to an operator of the bag-making packaging machine 1, and accepts various commands input to the bag-making packaging machine 1.

(1-2) Gusseted Bag

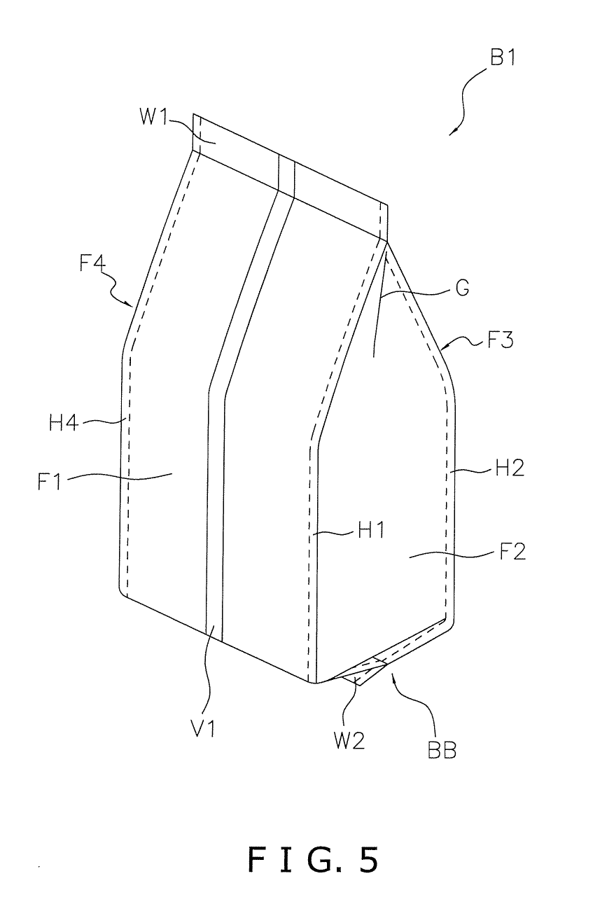

As shown in FIG. 5, the bag-making packaging machine 1 manufactures a gusset-type bag B1 (hereafter, “gusseted bag B1”). The gusseted bag B1 has four lateral sides F1 to F4 and one bottom side BB. The gusseted bag B1 is a standing pack that is capable of standing independently, supported on the bottom side BB. In the gusseted bag B1 are formed four hem seal regions H1 to H4, one vertical seal region V1, one upper sideways seal region W1, and one lower sideways seal region W2. The vertical seal region V1 is formed in the lateral side FL The hem seal regions H1 to H4 form the four corners of the gusseted bag B1 as seen from above. Gussets (fold-in lines) G, G are formed in the lateral sides F2 and F4.

(1-3) Detailed Configuration

(1-3-1) Film Supply Unit

The film supply unit 6 supplies a sheet-shaped film F used as the material for the bag B1 to the bag-making packaging unit 5. The film supply unit 6 has a film roller 6a around which a single-ply (single-layered) sheet-shaped film F is wrapped. The film supply unit 6 reels the sheet-shaped film F off of the film roller 6a and supplies it to the bag-making packaging unit 5 in synchrony with the bag-making packaging unit 5.

(1-3-2) Bag-Making Packaging Unit

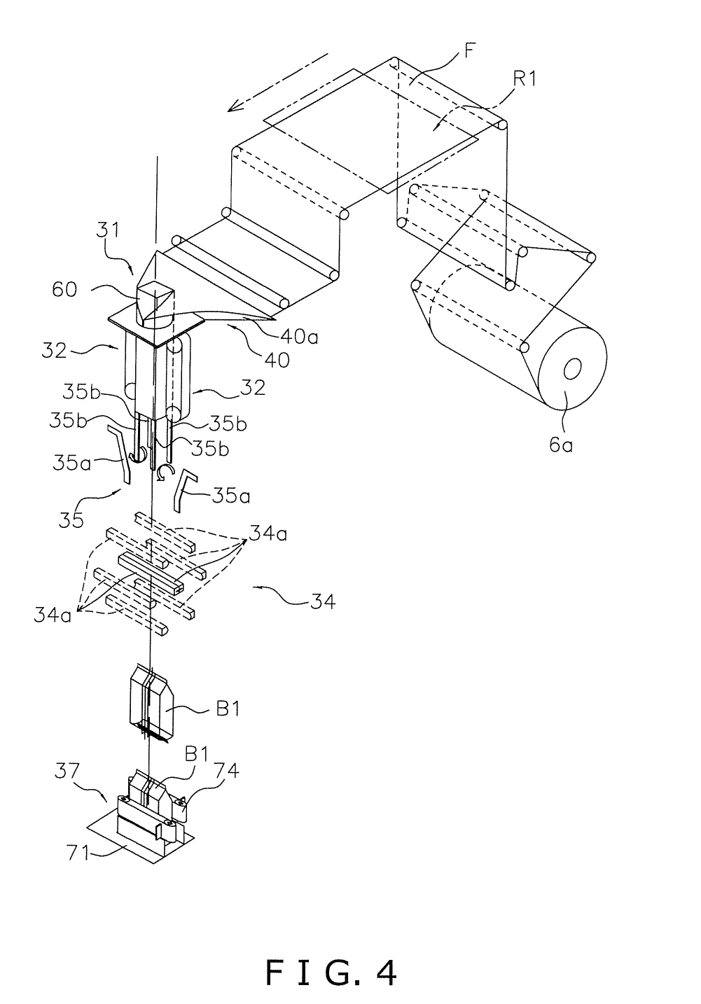

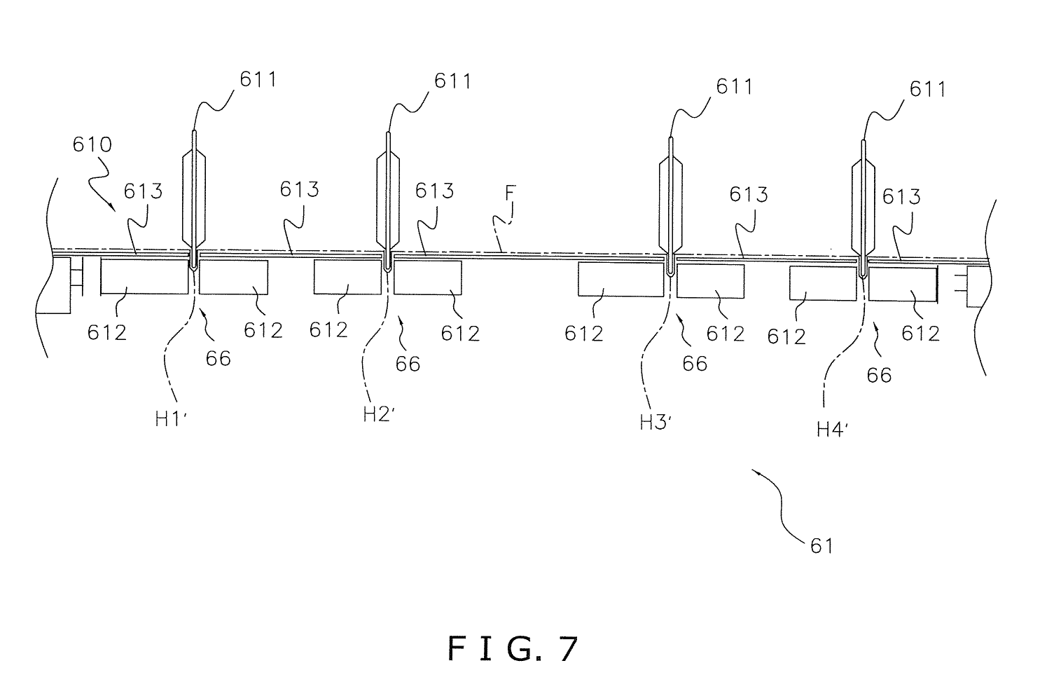

The bag-making packaging unit 5 includes a hem forming mechanism 61 (FIG. 7); a shaping mechanism 31 (FIGS. 3-4); pulldown belt mechanisms 32, 32 (FIGS. 3-4); a vertical sealing mechanism 33 (FIG. 3); a gusset forming mechanism 35 (FIGS. 3-4); a sideways sealing mechanism 34 (FIGS. 3-4); and a bottom forming mechanism 37 (FIG. 4).

(1-3-2-1) Hem Forming Mechanism

The hem forming mechanism 61 illustrated in FIG. 7 forms four hem seal regions H1 to H4 in the sheet-shaped film F. FIG. 7 depicts a view when looking the hem forming mechanism 61 downstream from upstream. The hem forming mechanism 61 is disposed above the conveyance route of the film F, and between the film supply unit 6 and the shaping mechanism 31 (in the area delineated by double-dashed line R1 in FIG. 4). The hem forming mechanism 61 has a conveyor surface 610, four insertion members 611, four pairs of heater blocks 612, and four pairs of rollers (not illustrated).

The conveyor surface 610 receives the sheet-shaped film F reeled out from the film supply unit 6 and guides it to the shaping mechanism 31. The sheet-shaped film F is conveyed along the conveyor surface 610 in contact with the conveyor surface 610. The conveyor surface 610 has five plate-like members 613 extending in the direction in which the film F is conveyed. The five plate-like members 613 are disposed so as to form four narrow gaps. As a result, four long and narrow grooves 66 extending in the direction in which the film F is conveyed are formed in the conveyor surface 610 between adjacent ones of the plate-like members 613.

The four insertion members 611 are each inserted into the four grooves 66 from above. Through contact with the insertion members 611, the film F is extends part-way into the grooves 66 at four locations. As a result, the sheet-shaped film F is partially folded over at four locations corresponding to the narrow grooves 66.

The four pairs of heater blocks 612 heat the four folded-over portions H1′ to H4′ of the film F within the grooves 66 from both sides of the grooves 66. The four pairs of rollers (not illustrated) are each disposed immediately downstream from the four pairs of heater blocks 612. The four pairs of rollers each sandwich the four heated portions H1′ to H4′ of the film F. As a result, the four portions H1′ to H4′ of the film F each become the hem seal regions H1 to H4.

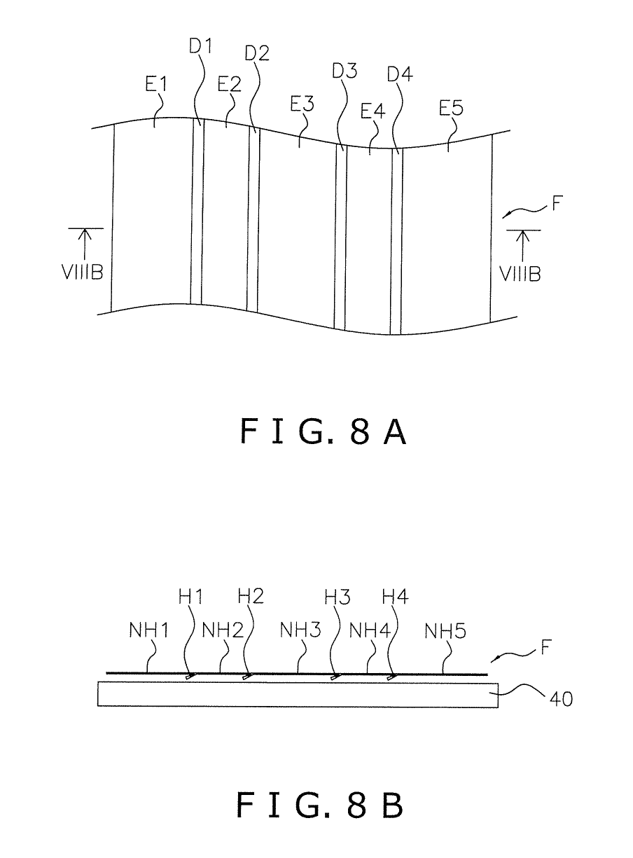

After leaving the hem forming mechanism 61, the film F is conveyed to a forming collar 40 described below of the shaping mechanism 31. As shown in FIGS. 8A and 8B, at the point in time when it reaches the forming collar 40, the film F includes the four hem seal regions H1 to H4 formed by the hem forming mechanism 61 and further includes five flat or non-hem sealed portions NH1 to NH5 that extend from either side of the four hem seal regions H1 to H4. The non-hem sealed portions NH1 to NH5 that have not been processed into a hem seal. The non-hem sealed portions NH1 to NH5 retain the single-layered film state at the time when they are reeled off of the film roller 6a. On the other hand, the hem seal regions H1 to H4 are formed by partially folding over the single-layered film and heat sealing the folded-over portions. In other words, the hem seal regions H1 to H4 constitute double-layered film sections. Thus, the hem seal regions H1 to H4 are thicker layered than the non-hem sealed portions NH1 to NH5.

As shown in FIG. 8B, when the hem seal regions H1 to H4 reach the forming collar 40, they incline to the right so as to overlap with or lightly touch the non-hem sealed portions NH1 to NH4. In other words, the hem seal regions H1 to H4 are sandwiched between the non-hem sealed portions NH1 to NH4 and the top side of the forming collar 40. Thus, when the film F reaches the forming collar 40, it has five thin portions E1 to E5 and four thick-layered portions D1 to D4. The thick-layered portions D1 to D4 in FIG. 8A are those portions where the respective hem seal regions H1 to H4 and non-hem sealed portions NH1 to NH4 overlap. Thus, the thick-layered portions D1 to D4 constitute triple-layered film sections. On the other hand, the thin portions E1 to E5 in FIG. 8A are those portions where the non-hem sealed portions NH1 to NH5 and hem seal regions H1 to H4 do not overlap. Thus, the thin portions E1 to E5 constitute single-layered film sections. Therefore, the thick-layered portions D1 to D4 are thicker layered than the thin portions E1 to E5 that constitute the rest of the film F. The thin portions E1 to E5 and the thick-layered portions D1 to D4 both extend in the direction in which the film F is conveyed. In other words, both the thin portions E1 to E5 and the thick-layered portions D1 to D4 are formed continuously and without interruption along the entire length of the film F along the conveyance direction. The thin portions E1 to E5 and the thick-layered portions D1 to D4 are alternately disposed in a transverse direction along the direction in which the film F is conveyed.

(1-3-2-2) Shaping Mechanism

The shaping mechanism 31 shown in FIGS. 3 and 4 shapes the sheet-shaped film F having the hem seal regions H1 to H4 into a square tubular film Fc. The shaping mechanism 31 has a tube 60 and a forming collar 40.

(1-3-2-2-1) Tube

The tube 60 is a square tubular-shaped member extending in the vertical direction, and has openings on upper and lower ends thereof. The upper opening of the tube 60 has a funnel shape. The tube 60 defines a conveyance direction of the articles C as the articles C are dropped into the film F that is subsequently formed into the product bag B1. In the depicted embodiment, the conveyance direction is a downward direction. As shown in FIG. 3, measured amounts of the articles C falling down from the combination weigher 2 (see FIG. 1) fall into the funnel-shaped upper opening and through the interior of the tube 60. The combination weigher 2 has a feeder, a pooling hopper, a weighing hopper, and a collecting/dispensing chute.

(1-3-2-2-2) Forming Collar

The forming collar 40 is disposed so as to surround the tube 60. The forming collar 40 guides the sheet-shaped film F so that the film F wraps around the tube 60. The forming collar 40 is affixed to the tube 60 by means of a bracket not shown in the drawings. The forming collar 40 has a sloped surface 40a. After leaving the hem forming mechanism 61, the sheet-shaped film F reaches the forming collar 40. The film F is conveyed obliquely upwards along the sloped surface 40a while in contact with the sloped surface 40a.

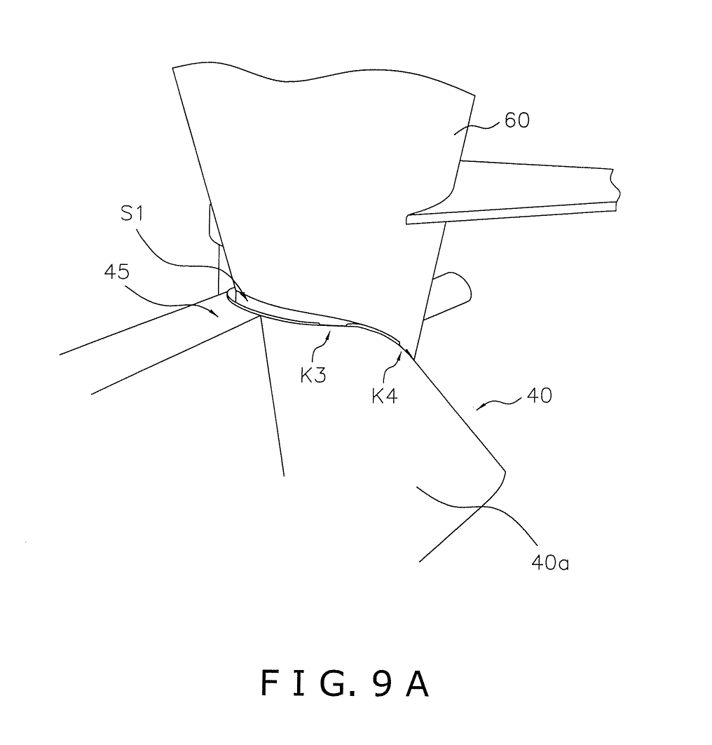

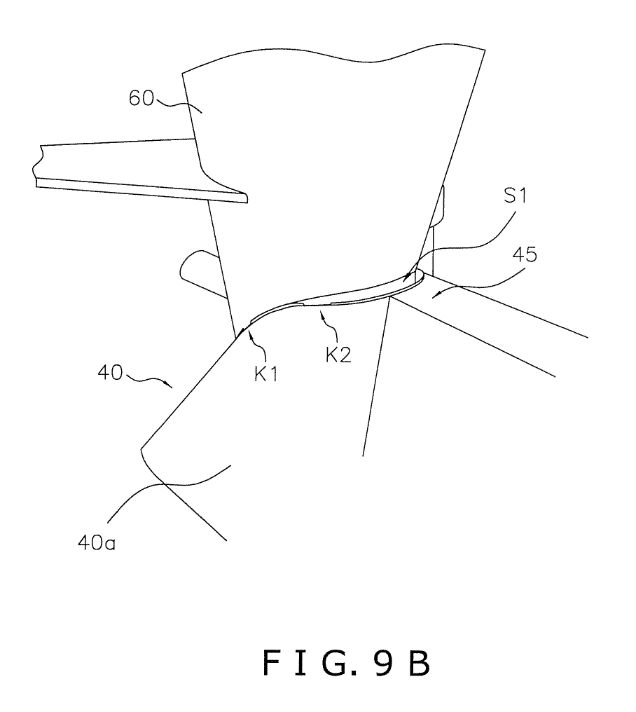

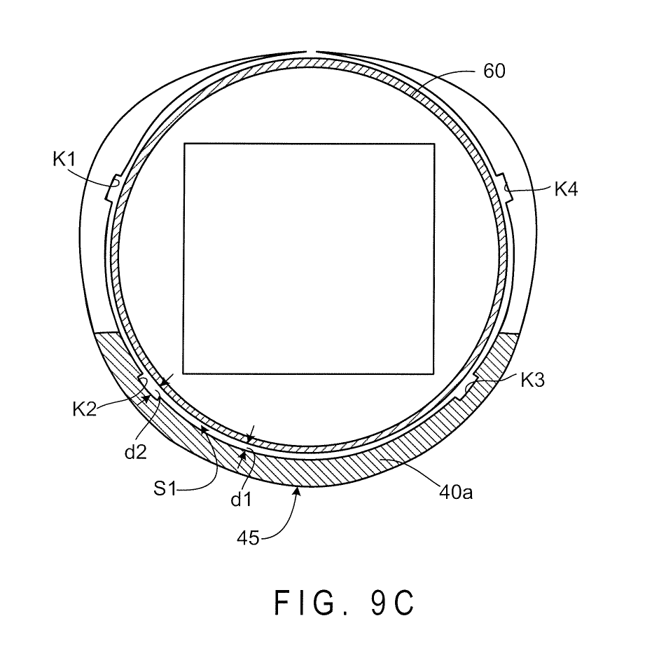

As shown in FIGS. 9A and 9B, a narrow gap S1 is formed between the outer surface of the tube 60 and the forming collar 40. The gap 51 is present along the entire periphery of the tube 60. After rising to the top of the sloped surface 40a, the film F is inserted into the gap S1. As it passes through the gap S1, the film F is wrapped around the outer surface of the square tubular tube 60. As a result, the shape of the film F is changed from that of a sheet to that of a square tube. When the film F is wrapped around the tube 60, the hem seal regions H1 to H4 are disposed so as to form four corners of the square tubular film Fc extending in the vertical direction. Afterwards, the square tubular film Fc is conveyed downwards along the outer surface of the tube 60 so as to envelop the tube 60.

A portion of the forming collar 40 near the apex of the sloped surface 40a is referred to as a folded-back portion 45, as shown in FIGS. 9A, 9B and 9C. The folded-back portion 45 is present along the entire periphery of the tube 60. The folded-back portion 45 defines the gap S1. After proceeding along the sloped surface 40a, the film F is folded back in an approximately perpendicularly downward direction by the folded-back portion 45. In other words, the film F initially moves in a first direction shown in FIG. 3, that is generally horizontal. The folded-back portion 45 abruptly changes the direction in which the film F is advancing to an approximately perpendicularly downward direction near the apex of the sloped surface 40a. In other words, movement of the film F changes from the first direction (horizontal direction) to the perpendicular conveyance direction (downward). After being abruptly folded back by the folded-back portion 45, the film F is immediately inserted into the gap S1. The width of the gap S1 is narrow enough that the film F is firmly wrapped around the tube 60. Thus, the load (friction) exerted upon the film F near the folded-back portion 45 is relatively large.

As described above, the film F has thin portions E1 to E5 constituting single-layered film sections, and thick-layered portions D1 to D4 constituting triple-layered film sections. If the width of the gap S1 is set while giving consideration only to the thin portions E1 to E5, which occupy the greater half of the film F, there is a danger of placing excessive load (friction) upon the thick-layered portions D1 to D4. In such case, the heat seals of the hem seal regions H1 to H4 may be damaged or the film F may be otherwise injured. On the other hand, if only the thick-layered portions D1 to D4 are taken into consideration when setting the width of the gap S1, it becomes more difficult to obtain a square tubular film Fc having a favorable shape. This is because, if the width of the gap S1 is too great, the film F will not readily wrap firmly around the tube 60.

Thus, in the present embodiment, four cutouts K1 to K4 are formed in the folded-back portion 45 of the forming collar 40, as illustrated in FIGS. 9A, 9B and 9C. The four cutouts K1 to K4 each correspond to the four hem seal regions H1 to H4 of the film F. The spaces defined by the cutouts K1 to K4 form part of the gap S1. In other words, because of the presence of the cutouts K1 to K4, there are both portions that are broad with respect to the peripheral direction and portions that are narrow with respect thereto in the gap S1. The portions within the gap Si that are broad along the peripheral direction form channels through which the thick-layered portions D1 to D4 of the entire film F pass. The portions within the gap S1 that are narrow along the peripheral direction form channels through which the thin portions E1 to E5 of the entire film F pass. In other words, the cutouts K1 to K4 are formed in the folded-back portion 45 at positions through which the respective thick-layered portions D1 to D4 pass. The four cutouts K1 to K4 serve the role of allowing the four thick-layered portions D1 to D4 of the film F to pass by safely and undamaged. The forming collar 40 is positioned such that the gap Si is defined between the forming collar 40 and the tube 60. A first distance d1 is defined between the forming collar 40 and tube 60 measured at the gap S1. A second distance d2 is defined between the forming collar 40 and the tube 60 at the cutouts K1 to K4, the second distance being greater than the first distance.

(1-3-2-3) Pulldown Belt Mechanism

As shown in FIGS. 3 and 4, the pulldown belt mechanisms 32, 32 are disposed symmetrically on either side of the tube 60. The pulldown belt mechanisms 32, 32 each extend in the vertical direction along the tube 60. The pulldown belt mechanisms 32, 32 each have driving rollers 32b, 32b; driven rollers 32c, 32c; and belts 32a, 32a. The driving rollers 32b, 32b are continuously driven by a motor not shown in the drawings. The driven rollers 32c, 32c each rotate in response to the rotation of the driving rollers 32b, 32b. The belts 32a, 32a suction the square tubular film Fc. As a result, the pulldown belt mechanisms 32, 32 convey the square tubular film Fc downwards along the outer surface of the tube 60 while suctioning the film Fc.

(1-3-2-4) Vertical Sealing Mechanism

The vertical sealing mechanism 33 is disposed upon a front surface of the tube 60. The vertical sealing mechanism 33 extends in a vertical direction with respect to the tube 60. The vertical sealing mechanism 33 has a heater, a heater belt that is heated by the heater, and a drive apparatus for moving the heater belt towards and away from the tube 60. As shown in FIG. 3, the vertical sealing mechanism 33 heat-seals the portion where the left edge and the right edge of the square tubular film Fc wrapped around the tube 60 overlap in a vertical direction by pressing the overlapping portion against the tube 60 with a fixed amount of pressure while heating. As a result, a vertical seal region V1 is formed in the square tubular film Fc.

(1-3-2-5) Gusset Forming Mechanism

The gusset forming mechanism 35 forms gussets G, G in the gusseted bag B1. As illustrated in FIGS. 3, 4, 10A, and 10B, the gusset forming mechanism 35 is disposed between the pulldown belt mechanisms 32, 32 and the sideways sealing mechanism 34 with respect to the vertical direction. The gusset forming mechanism 35 has four guides 35b, 35b . . . and a pair of crimpers 35a, 35a.

The four guides 35b, 35b . . . extend downwards from the four corners of the lower end of the tube 60. The guides 35b, 35b . . . are thin plate-like members. After being conveyed while surrounding the tube 60, the square tubular film Fc is further conveyed downwards while surrounding the guides 35b, 35b . . . .

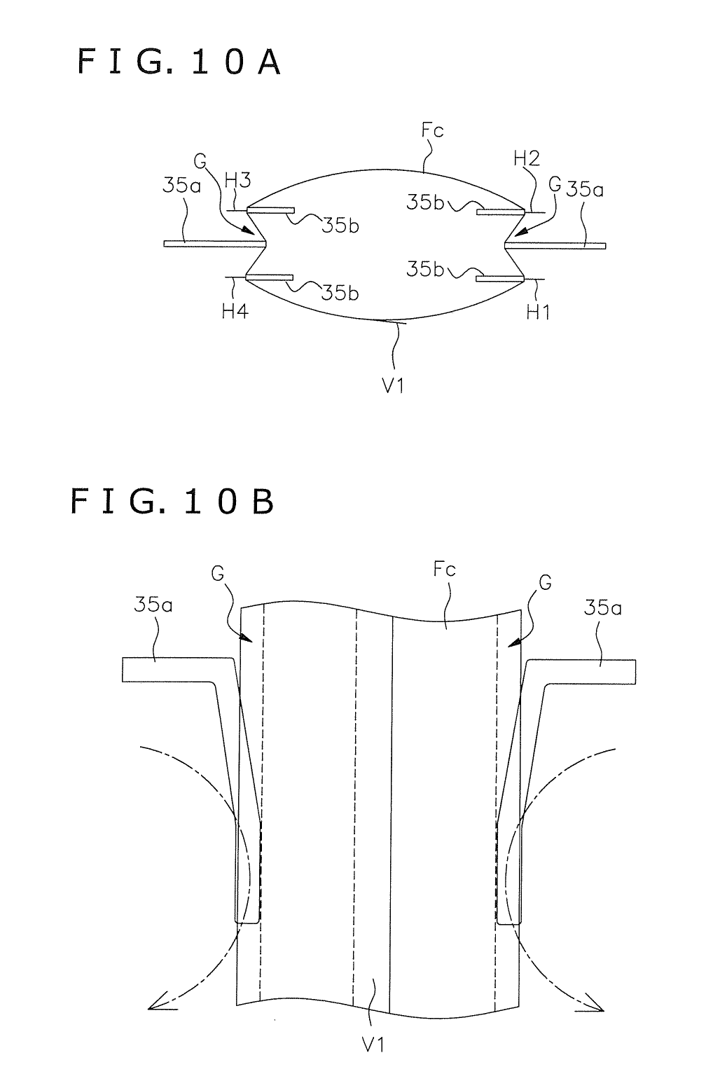

The crimpers 35a, 35a are thin strip-shaped members. As shown in FIG. 10B, the crimpers 35a, 35a symmetrically draw near to and away from the left and right sides of the square tubular film Fc while being driven by a motor not shown in the drawings along an approximately circular path. As shown in FIG. 10A, when the crimpers 35a, 35a are in closest proximity to each other, they enter into the spaces between the guides 35b, 35b . . . . As a result, the left and right sides of the square tubular film Fc are folded inwards to form gussets G, G.

(1-3-2-6) Sideways Sealing Mechanism

As shown in FIG. 3, the sideways sealing mechanism 34 is disposed beneath the gusset forming mechanism 35. The sideways sealing mechanism 34 has a pair of sealing jaws 34a, 34a.

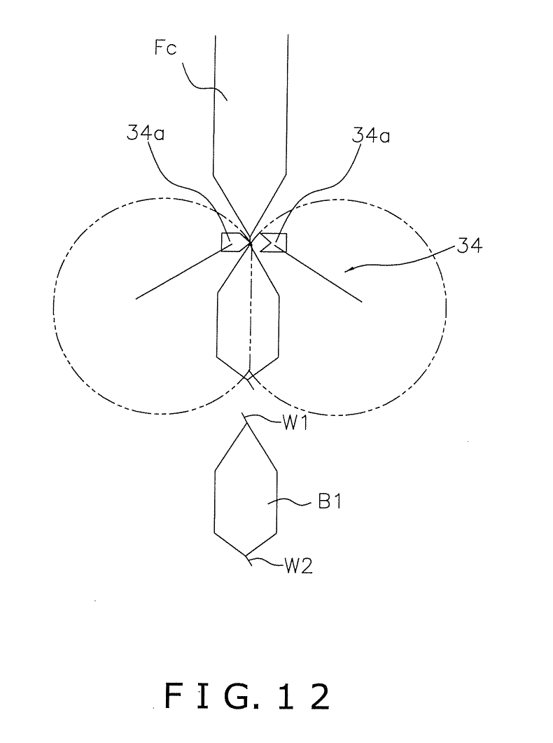

The sealing jaws 34a, 34a each extend in the left and right directions. As shown in FIG. 12, the sealing jaws 34a, 34a revolve in synchrony with each other along a D-shaped path, and symmetrically draw near to and away from the front and back of the square tubular film Fc. When in closest proximity to each other, the sealing jaws 34a, 34a pinch the square tubular film Fc therebetween. The portion of the square tubular film Fc pinched between the sealing jaws 34a, 34a is heated by the heater provided within the sealing jaws 34a, 34a to form a heat seal in the lateral direction. In a single pinching action, both an upper sideways seal region W1 of a leading bag B1 (with an unformed bottom side BB; hereinafter, square tubular bag B1) and a lower sideways seal region W2 of a following bag B1 (with both an unformed bottom side BB and an unformed upper sideways seal region W1) are formed simultaneously. One sealing jaw 34a has a built-in cutter. The cutter cuts the center of the heat sealed portion of the square tubular film Fc in the lateral direction while the square tubular film Fc is pinched between the sealing jaws 34a, 34a. As a result, the square tubular bag B1 is cut off.

(1-3-2-7) Bottom Forming Mechanism

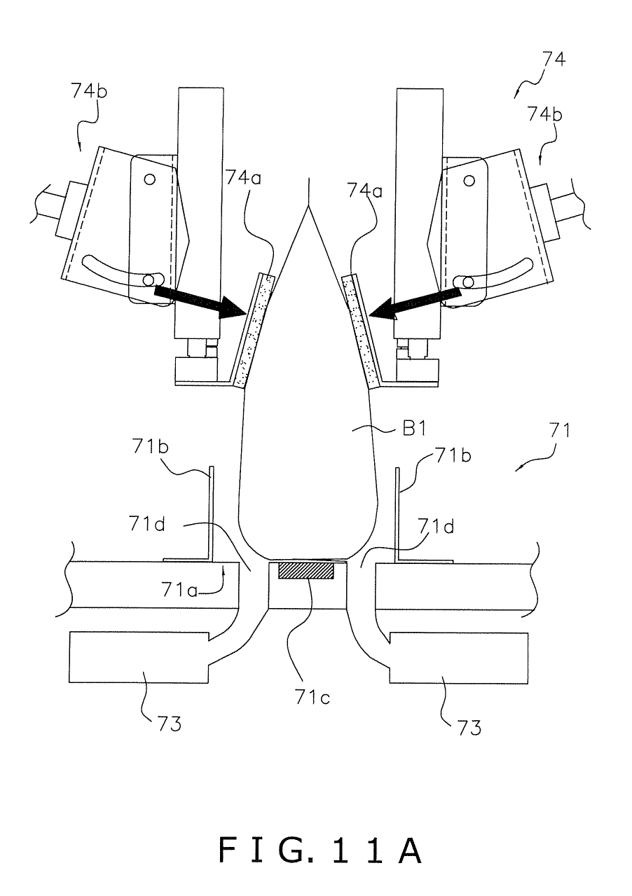

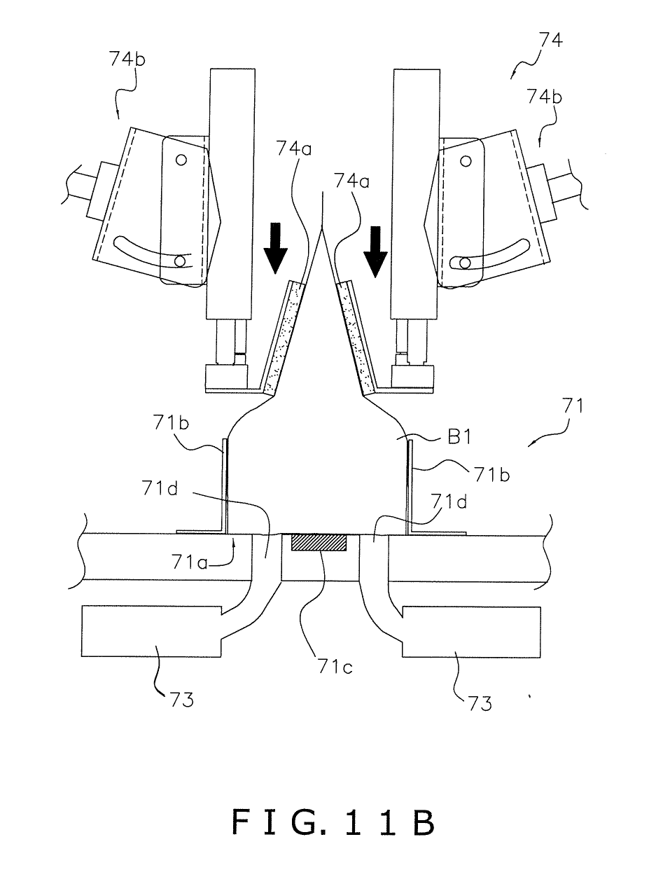

The bottom forming mechanism 37 is disposed beneath the sideways sealing mechanism 34, as shown in FIG. 4. The bottom forming mechanism 37 forms the horizontal bottom side BB of the gusseted bag B1. The bottom forming mechanism 37 has a bag receiving part 71; vacuums 73, 73; and a pushing unit 74, as shown in FIGS. 11A and 11B.

The bag receiving part 71 has a horizontal surface 71a and vertical surfaces 71b, 71b rising upwards vertically from the horizontal surface 71a. The horizontal surface 71a catches the square tubular bag B1 dropping down from the sideways sealing mechanism 34 from beneath. The vertical surfaces 71b, 71b sandwich the square tubular bag B1 from the front and rear. The lower sideways seal region W2 of the square tubular bag B1 and a portion of the main body corresponding to the bottom side thereof (to become the bottom side BB later) contact the horizontal surface 71a. The main body of the square tubular bag B1 corresponds to all portions of the square tubular bag B1 other than the upper sideways seal region W1 and the lower sideways seal region W2. In the center of the horizontal surface 71a is disposed a heater 71c extending to the left and right. The heater 71c heat-seals the lower sideways seal region W2 and the part corresponding to the bottom side.

The vacuums 73, 73 provide suction from beneath upon the part corresponding to the bottom side through a plurality of holes 71d, 71d formed in the horizontal surface 71a. As a result, when the square tubular bag B1 drops onto the horizontal surface 71a, the part corresponding to the bottom side is held fast to the horizontal surface 71a.

The pushing unit 74 presses the square tubular bag B1 from above against the bag receiving part 71. The pushing unit 74 has contact members 74a, 74a and motion mechanisms 74b, 74b. The contact members 74a, 74a contact the square tubular bag B1 on the front and rear sides, respectively. The motion mechanisms 74b, 74b move the respective contact members 74a, 74a forward and backward (see FIG. 11A) as well as up and down (see FIG. 11B). As a result, a bottom side BB is formed in the square tubular bag B1.

(1-3-2-8) Control Unit

FIG. 6 shows a control unit 7 connected to the various sections of the bag-making packaging machine 1. Although not shown, the control unit 7 includes elements such as a CPU, ROM, RAM, and flash memory. The control unit 7 controls the action of the various parts of the bag-making packaging machine 1 by reading out and executing a program stored within the flash memory. As shown in FIG. 6, the control unit 7 is connected to the film supply unit 6, the hem forming mechanism 61, the pulldown belt mechanisms 32, 32, the vertical sealing mechanism 33, the gusset forming mechanism 35, the sideways sealing mechanism 34, the bottom forming mechanism 37, and the operating panel 8. The control unit 7 is also connected to the combination weigher 2.

(1-4) Operating Process of the Bag-Making Packaging Machine

When the pulldown belt mechanisms 32, 32 are driven, the sheet-shaped film F is reeled off of the film roller 6a. After being reeled off of the film roller 6a, the sheet-shaped film F arrives at the hem forming mechanism 61. The hem forming mechanism 61 forms hem seal regions H1 to H4 in the sheet-shaped film F.

Next, the sheet-shaped film F having the hem seal regions H1 to H4 arrives at the shaping mechanism 31. The shaping mechanism 31 shapes the sheet-shaped film F into a square tubular film Fc. At this point, the two edges of the sheet-shaped film F in the lateral (right/left) direction overlap in the vertical (up/down) direction.

Next, the square tubular film Fc having the vertically overlapping portion descends along the tube 60 towards the vertical sealing mechanism 33. The vertical sealing mechanism 33 forms a vertical seal region V1 in the square tubular film Fc by heat sealing the vertically overlapping portion of the square tubular film Fc.

Next, the square tubular film Fc having the vertical seal region V1 descends out of the tube 60 towards the gusset forming mechanism 35. The gusset forming mechanism 35 forms gussets G, G in the square tubular film Fc by folding predetermined portions of the square tubular film Fc.

Next, the square tubular film Fc having the gussets G, G descends past the guides 35b, 35b . . . towards the sideways sealing mechanism 34. At a timing coinciding with this, the articles C drop from the combination weigher 2 through the interior of the tube 60 towards the interior of the square tubular film Fc. The control unit 7 commands a controller (not illustrated) of the combination weigher 2 to drop the articles C at an appropriate timing. The sideways sealing mechanism 34 heat seals a predetermined portion of the square tubular film Fc in the lateral direction in the state that the square tubular film Fc is filled with the articles C. At the same time, the sideways sealing mechanism 34 cuts, in the lateral direction, the center of the predetermined portion heat-sealed of the square tubular film Fc. As a result, a square tubular bag B1 is cut off from the square tubular film Fc.

After being cut off from the square tubular film Fc, the square tubular bag B1 drops towards the bottom forming mechanism 37. The bottom forming mechanism 37 corrects the posture of the square tubular bag B1 while forming a bottom side BB in the square tubular bag B1. As a result, a squared gusseted bag B1 having the bottom side BB as shown in FIG. 5 is formed.

(1-5) Characteristics

In the present embodiment, cutouts K1 to K4 are formed in the folded-back portion 45 of the forming collar 40 so that the thick-layered portions D1 to D4 of the film F can easily pass therethrough. Because of this, when the film F passes by the folded-back portion 45, the friction exerted upon the thick-layered portions D1 to D4 of the film F as it enters the narrow gap Si between the tube 60 and the forming collar 40 is reduced. Thus, it is possible to prevent damage to the film F having the thick-layered portions D1 to D4.

In other words, the cutouts K1 to K4 are formed in four locations in the folded-back portion 45 of the forming collar 40 so that the four hem seal regions H1 to H4 can easily pass therethrough. This reduces the friction exerted upon the four hem seal regions H1 to H4. Thus, it is possible to prevent damage to the film F having the hem seal regions H1 to H4.

Erratic movement of the film F is prevented by the hem seal regions H1 to H4 being conveyed so as to pass through the spaces defined by the cutouts K1 to K4, respectively.

### (2) Second Embodiment

The bag-making packaging machine 1 according to the first embodiment is partially rearranged to form a bag-making packaging machine 101 of a second embodiment. The bag-making packaging machine 101 according to the second embodiment will be described below, focusing on the differences with the bag-making packaging machine 1 according to the first embodiment. All components shared with the first embodiment bear the same number, and description thereof will be omitted.

(2-1) Pillow Bag

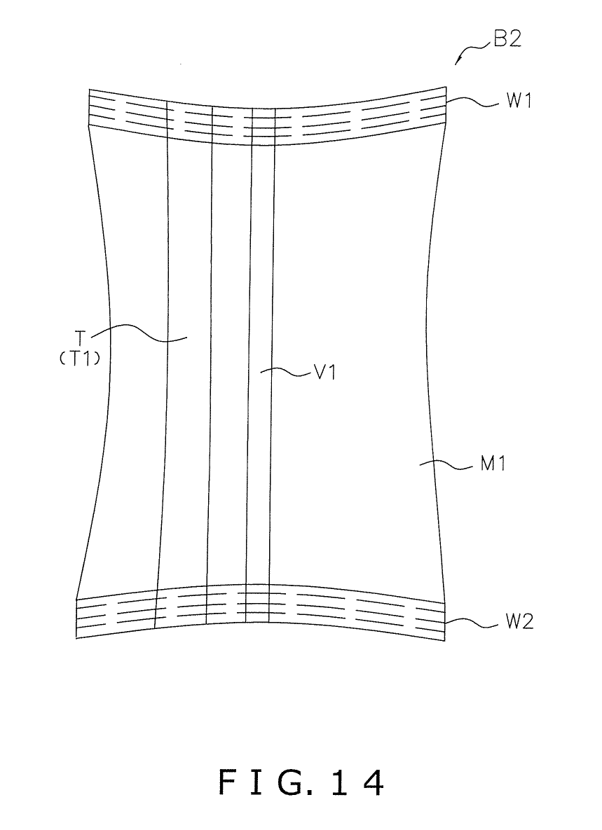

The bag-making packaging machine 101 manufactures a pillow-shaped bag B2 (hereafter, “pillow bag B2”) as shown in FIG. 14. The pillow bag B2 has a main bag M1 and a tape T attached to the main bag M1. A vertical seal region V1, an upper sideways seal region W1, and a lower sideways seal region W2 are formed in the main bag M1. The heat sealed portion, where the main bag M1 and the tape T are heat sealed will be referred to as tape seal region T1. The tape seal region T1 extends parallel to the vertical seal region V1 somewhat towards the left side of the pillow bag B2. The tape T can be used for various purposes, such as an advertising banner or a product coupon.

(2-2) Detailed Configuration

The bag-making packaging machine 101 for manufacturing the pillow bag B2 is obtained by exchanging the film supply unit 6 of the bag-making packaging machine 1, which manufactures a gusseted bag B1, for a film supply unit 106, and the bag-making packaging unit 5 for a bag-making packaging unit 105. Unlike the gusseted bag B1, there are no hem seal regions H1 to H4, gussets G, G, or bottom side BB formed in the pillow bag B2. Thus, in order to reconfigure the bag-making packaging machine 1 into the bag-making packaging machine 101, the hem forming mechanism 61, the gusset forming mechanism 35, and the bottom forming mechanism 37 are removed. Also, unlike the gusseted bag B1, the pillow bag B2 has the tape T. Therefore, a tape roller 6b and a tape welding mechanism 138 are installed in the bag-making packaging machine 101. Unlike the gusseted bag B1, the shape of the pillow bag B2 is not that of a square tube but rather that of an ellipsoidal tube. Therefore, a shaping mechanism 131 is installed in the bag-making packaging machine 101 in place of the shaping mechanism 31.

(2-2-1) Film Supply Unit

The film supply unit 106 supplies a sheet-shaped film F used as the material for the main bag M1 and tape T to the bag-making packaging unit 105. The film supply unit 106 has a film roller 6a around which a single-ply (single-layered) sheet-shaped film F is wrapped, and a tape roller 6b around which single-ply (single-layered) tape T is wrapped. The film supply unit 106 reels the sheet-shaped film F off of the film roller 6a and the tape T off of the tape roller 6b and supplies both to the bag-making packaging unit 105 in synchrony with the bag-making packaging unit 105. The tape T reeled off of the tape roller 6b is conveyed towards the bag-making packaging unit 105 while in contact with the lower surface of the sheet-shaped film F reeled off of the film roller 6a.

(2-2-2) Bag-Making Packaging Unit

The bag-making packaging unit 105 has a tape welding mechanism 138, a shaping mechanism 131, pulldown belt mechanisms 32, 32, a vertical sealing mechanism 33, and a sideways sealing mechanism 34.

(2-2-2-1) Tape Welding Mechanism

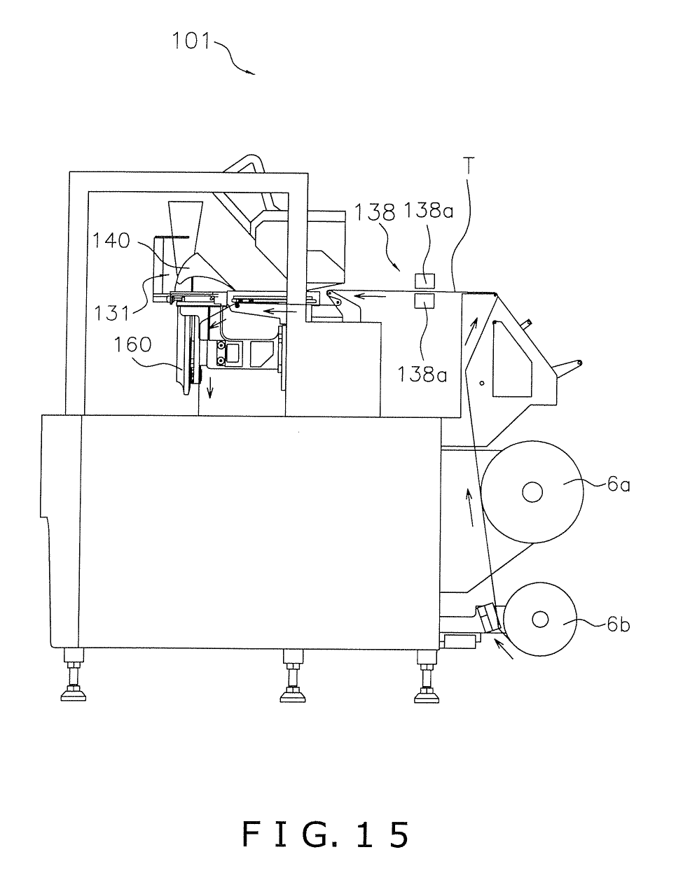

The tape welding mechanism 138 heat seals the tape T reeled off of the tape roller 6b to the sheet-shaped film F reeled off of the film supply unit 106 to create a single piece. The tape welding mechanism 138 is disposed between the film supply unit 106 and the shaping mechanism 131 along the conveyance path of the film F. As shown in FIG. 15, the tape welding mechanism 138 has a pair of heater blocks 138a, 138a and a pair of rollers (not illustrated).

The heater blocks 138a, 138a are disposed so as to leave a narrow gap therebetween. The overlapping portions of the sheet-shaped film F and the tape T are conveyed into the gap between the heater blocks 138a, 138a in contact therewith. The heater blocks 138a, 138a heat the overlapping portions of the film F and the tape T from either side of the gap. The pair of rollers (not illustrated) is disposed immediately downstream from the pair of heater blocks 138a, 138a. The heated overlapping portions of the film F and the tape T are sandwiched between the pair of rollers. As a result, the overlapping portions of the film F and the tape T are heat sealed to form a tape seal region T1.

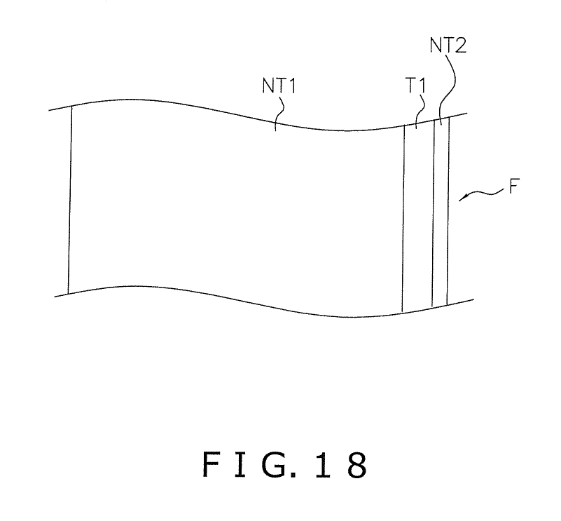

After leaving the tape welding mechanism 138, the film F is conveyed to a forming collar 140 described below of the shaping mechanism 131. As shown in FIG. 18, upon arriving at the forming collar 140, the film F has one tape seal region T1 where the tape T has been heat sealed and two non-tape-sealed regions NT1, NT2 where the tape T has not been heat sealed. The non-tape-sealed regions NT1, NT2 retain the single-layered film state at the time when it is reeled off of the film roller 6a. On the other hand, the tape seal region T1 is formed by heat sealing a single-layered film (the tape) to the single-layered film. In other words, the tape seal region T1 constitutes a double-layered film section. Thus, the tape seal region T1 is a thicker layer than the non-tape-sealed regions NT1, NT2. Both the tape seal region T1 and the non-tape-sealed regions NT1, NT2 extend in the direction in which the film F is conveyed. In other words, both the tape seal region T1 and the non-tape-sealed regions NT1, NT2 are formed continuously and without interruption in the conveyance direction along the entirety of the film F. The tape seal region T1 and the non-tape-sealed regions NT1, NT2 are lined up alternately in lateral direction along the direction in which the film F is conveyed.

(2-2-2-2) Shaping Mechanism

The shaping mechanism 131 shapes the sheet-shaped film F having the tape seal region T1 into a cylindrical film Fd. The shaping mechanism 131 has a tube 160 and a forming collar 140.

(2-2-2-2-1) Tube

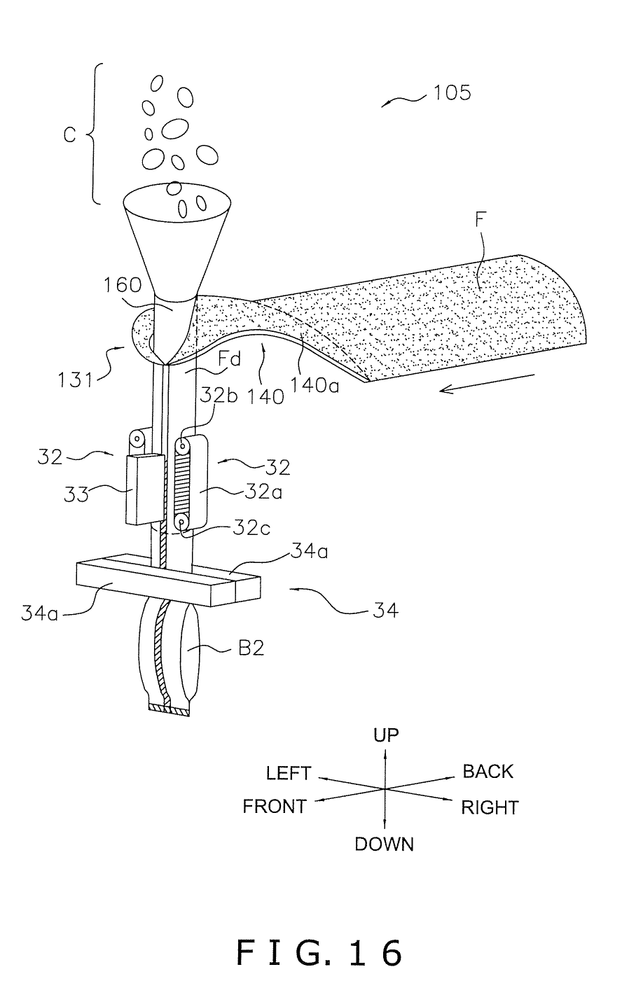

The tube 160 is a cylindrical member extending in the vertical direction, and has openings on upper and lower ends thereof. The upper opening of the tube 160 has a funnel shape. As shown in FIG. 16, predetermined amounts of the articles C falling down from the combination weigher 2 (see FIG. 13) fall into the funnel-shaped upper opening and through the interior of the tube 160.

(2-2-2-2-2) Forming Collar

The forming collar 140 is disposed so as to surround the tube 160. The forming collar 140 guides the sheet-shaped film F so that the film F wraps around the tube 160. The forming collar 140 is affixed to the tube 160 via a bracket not shown in the drawings. The forming collar 140 has a sloped surface 140a. After leaving the tape welding mechanism 138, the sheet-shaped film F reaches the forming collar 140. The film F is conveyed obliquely upwards along the sloped surface 140a while in contact with the sloped surface 140a.

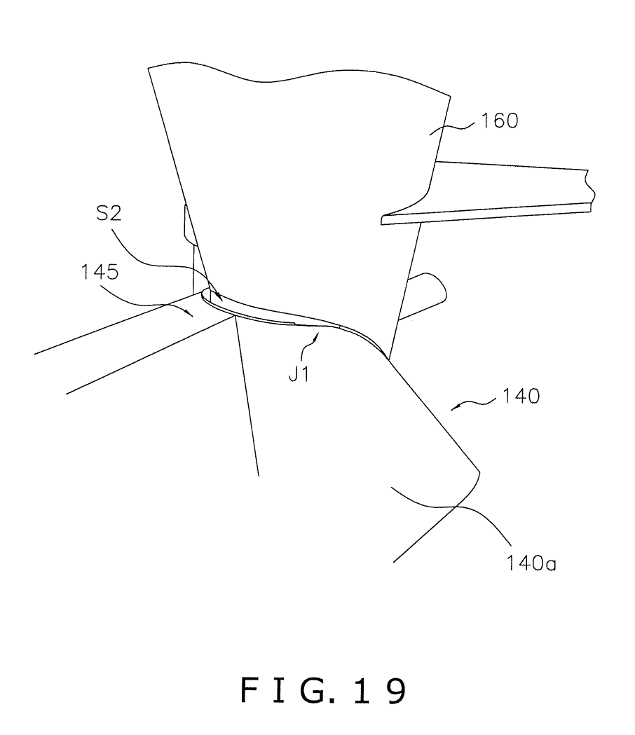

As shown in FIG. 19, a narrow gap S2 is formed between the outer surface of the tube 160 and the forming collar 140. The gap S2 is present along the entire periphery of the tube 160. After rising to the top of the sloped surface 140a, the film F is inserted into the gap S2. As it passes through the gap S2, the film F is wrapped around the outer surface of the cylindrical tube 160. As a result, the shape of the film F is changed from that of a sheet to that of a cylinder. Afterwards, the cylindrical film Fd is conveyed downwards along the outer surface of the tube 160 so as to envelop the tube 160.

The portion of the forming collar 140 near the apex of the sloped surface 140a is referred to as a folded-back portion 145. The folded-back portion 145 is present along the entire periphery of the tube 160. The folded-back portion 145 defines the gap S2. After proceeding along the sloped surface 140a, the film F is folded back in an approximately perpendicularly downward direction by the folded-back portion 145. In other words, the folded-back portion 145 abruptly changes the direction in which the film F is proceeding to an approximately perpendicularly downward direction near the apex of the sloped surface 140a. After being abruptly folded back by the folded-back portion 145, the film F is immediately inserted into the gap S2. The width of the gap S2 is narrow enough that the film F is firmly wrapped around the tube 160. Thus, the load (friction) exerted upon the film F near the folded-back portion 145 is relatively large.

As described above, the film F has non-tape-sealed regions NT1, NT2 that constitute single-layered film sections, and a tape seal region T1 that constitutes a double-layered film section. If the width of the gap S2 is set while giving consideration only to the non-tape-sealed regions NT1, NT2, which occupy the greater half of the film F, there is a danger of placing excessive load (friction) upon the tape seal region T1. In such case, the heat seal of the tape seal region T1 may be damaged or the film F may be easily damaged. On the other hand, if only the tape seal region T1 is taken into consideration when setting the width of the gap S2, it becomes more difficult to obtain a cylindrical film Fd having a favorable shape. This is because, if the width of the gap S2 is too great, the film F will not wrap firmly around the tube 160.

Thus, in the present embodiment, a cutout J1 is formed in one location in the folded-back portion 145 of the forming collar 140, as illustrated in FIG. 19. The cutout J1 corresponds to the tape seal region T1 of the film F. The space defined by the cutout J1 constitutes part of the gap S2. In other words, because of the presence of the cutout J1, there are both a broad portion and narrow portions in the gap S2 along the peripheral direction. The portion within the gap S2 that is broad with respect to the peripheral direction forms the channel through which passes the tape seal region T1 of the entirety of the film F. The portions within the gap S2 that are narrow with respect to the peripheral direction form channels through which pass the non-tape-sealed regions NT1, NT2 of the entirety of the film F. In other words, the cutout J1 is formed at a location of the folded-back portion 145 through which the tape seal region T1 passes. The cutout J1 serves the role of allowing the tape seal region T1 of the film F to pass by safely and undamaged.

(2-3) Operating Process of the Bag-Making Packaging Machine

When the pulldown belt mechanisms 32, 32 are driven, the sheet-shaped film F is reeled off of the film roller 6a and the tape T is reeled off of the tape roller 6b. The sheet-shaped film F reeled off of the film roller 6a and the tape T reeled off of the tape roller 6b are conveyed to the tape welding mechanism 138 in an overlapping state. The tape welding mechanism 138 forms a tape seal region T1 in the sheet-shaped film F.

Next, the sheet-shaped film F having the tape seal region T1 arrives at the shaping mechanism 131. The shaping mechanism 131 shapes the sheet-shaped film F into a cylindrical film Fd. At this point, the two edges of the sheet-shaped film F in the lateral (left/right) direction overlap in the vertical (up/down) direction.

Next, the cylindrical film Fd having the vertically overlapping portions descends along the tube 160 towards the vertical sealing mechanism 33. The vertical sealing mechanism 33 forms a vertical seal region V1 in the cylindrical film Fd by heat sealing the vertically overlapping portion of the cylindrical film Fd.

Next, the cylindrical film Fd having the vertical seal region V1 descends out of the tube 160 towards the sideways sealing mechanism 34. At a timing coinciding therewith, an articles C drops from the combination weigher 2 through the interior of the tube 160 towards the interior of the cylindrical film Fd. The control unit 7 commands a controller (not illustrated) of the combination weigher 2 to drop the articles C at an appropriate timing. The sideways sealing mechanism 34 heat seals a predetermined portion of the cylindrical film Fd in the left/right direction (lateral direction) with the cylindrical film Fd being filled with the articles C. At the same time, the sideways sealing mechanism 34 cuts, in the lateral direction, the center of the predetermined position heat-sealed of the cylindrical film Fd. As a result, a pillow bag B2 is cut from the cylindrical film Fd.

(2-4) Characteristics

In the present embodiment, a cutout J1 is formed in the folded-back portion 145 of the forming collar 140 so that the tape seal region T1 can easily pass therethrough. This reduces the friction applied to the tape T. Thus, damage to the film F having the tape T extending in the direction in which the film F advances can be prevented.

### (3) Modifications

First and second embodiments of the present invention were described above, but the present invention is not limited to these embodiments; various modifications are possible provided that they do not depart from the spirit of the invention. For instance, modifications such as the following are possible.

(3-1)

In the above embodiments, thick-layered portions D1 to D4 including hem seal regions H1 to H4 and a tape seal region T1 are given as examples of thick-layered portions of the film F. However, damage to the thick-layered portion can be avoided even when the film F has another type of thick-layered portion by forming a cutout in the folded-back portion 45 or 145 of the forming collar 40 or 140.

(3-2)

In the above embodiments, the thick-layered portions D1 to D4 including hem seal regions H1 to H4 and the tape seal region T1 extend continuously and without interruption in the direction in which the film F advanced. However, the thick-layered portion may also be present intermittently in the direction in which the film F advances. In such a case as well, the presence of the cutouts K1 to K4 or J1 enable damage to the thick-layered portion to be prevented.

(3-3)

The tape T may be conveyed above the film F rather than below so that the tape is finally disposed within the interior of the bag B2. In such a case as well, the presence of the cutout J1 enables damage to the thick-layered portion having the tape T to be prevented.

(3-4)

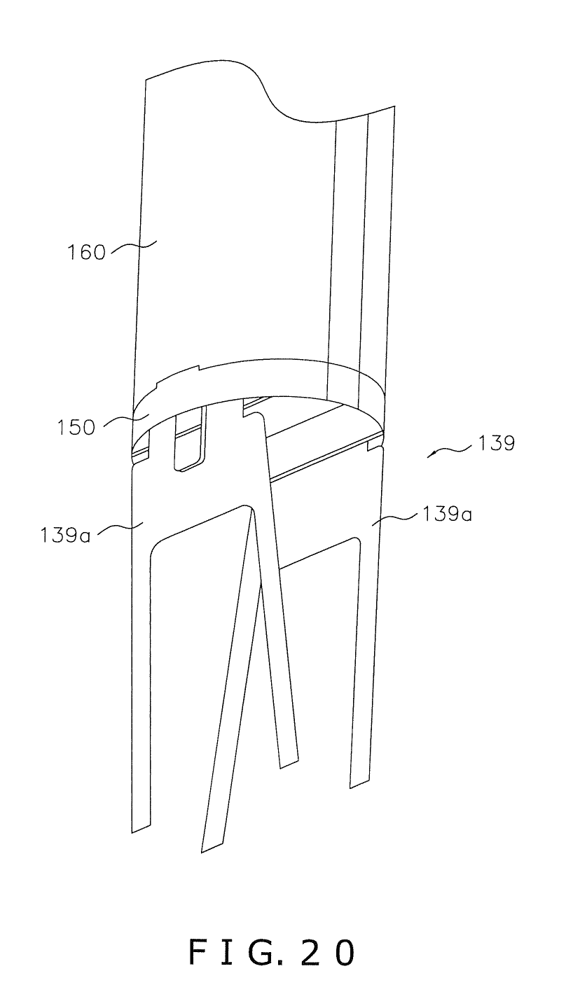

By partially reconfiguring the bag-making packaging machine 101 of the second embodiment, it is possible to manufacture a pillow-shaped bag having gussets G, G (gusseted pillow bag). In order to enable the manufacture of a gusseted pillow bag, a gusset forming mechanism 35 according to the first embodiment and a spreader mechanism 139 (see FIG. 20) may be added to the bag-making packaging machine 101.

As in the case of the first embodiment, the gusset forming mechanism 35 is installed between the pulldown belt mechanisms 32, 32 and the sideways sealing mechanism 34 in the vertical direction. The spreader mechanism 139 is installed on the lower end of the tube 160. The spreader mechanism 139 is removably attached to the tube 160.

The spreader mechanism 139 has a pair of spreaders 139a, 139a and a supporter 150 for supporting the pair of spreaders 139a, 139a. The spreaders 139a, 139a are thin strip-shaped members. The supporter 150 has an annular shape. The supporter 150 has a round shape approximately the same to that of the tube 160 as viewed from above. The spreaders 139a, 139a are suspended from the front and rear sides of the supporter 150, respectively.

After being conveyed along while surrounding the tube 160, the cylindrical film Fd is further conveyed downwards while surrounding the spreaders 139a, 139a. At this time, the spreaders 139a, 139a spread the cylindrical film Fd to the front and rear from within, suitably flattening the left and right sides of the cylindrical film Fd. As a result, gussets G, G are stably formed.

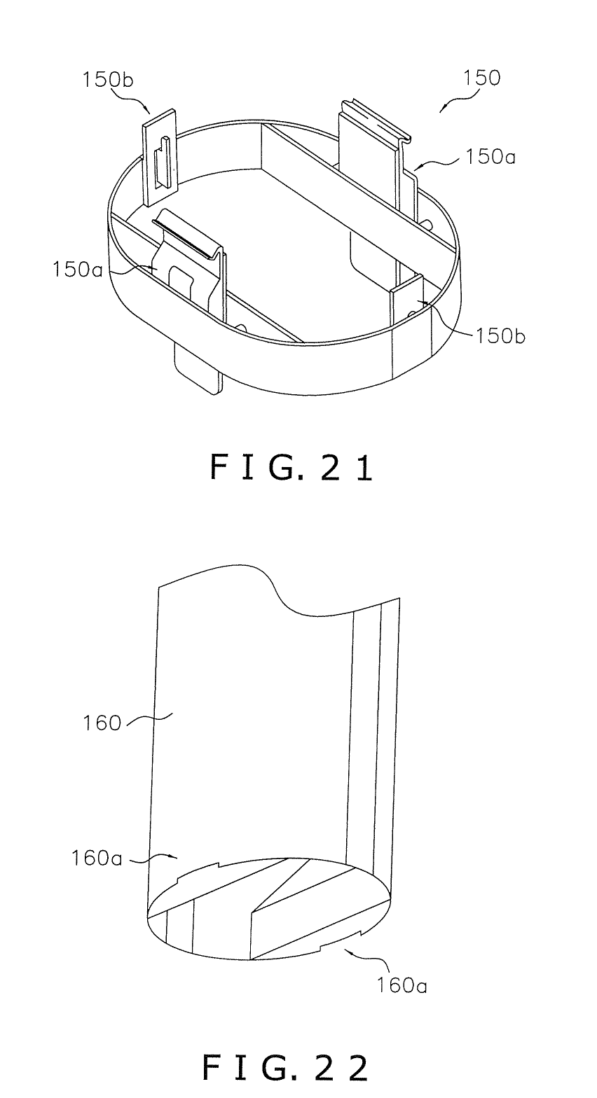

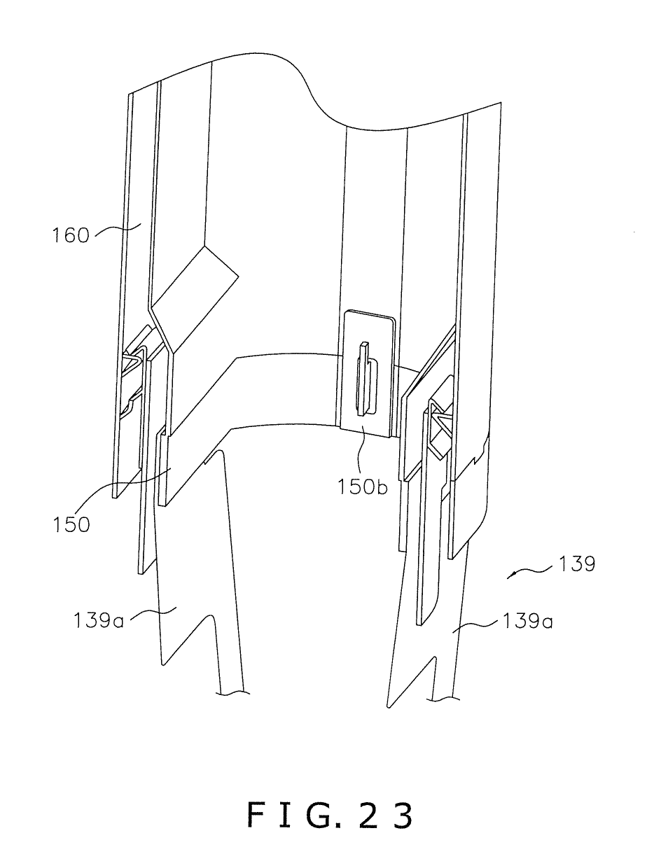

As shown in FIG. 21, the front and rear surfaces of the supporter 150 have ridges (convex grooves) 150a, 150a. The supporter 150 also has catches 150b, 150b on its right and left sides. As shown in FIG. 22, grooves (concave grooves) 160a, 160a are formed on the lower ends of the front and rear surfaces of the tube 160. When the spreader mechanism 139 is installed on the tube 160, the ridges 150a, 150a of the supporter 150 are fitted into the grooves 160a, 160a of the tube 160, and the catches 150b, 150b of the supporter 150 catch upon the left and right interior surfaces of the tube 160 (see FIG. 23). At this time, the ridges 150a, 150a and catches 150b, 150b of the supporter 150 function as leaf springs. Thus, the supporter 150 can be easily installed upon the tube 160.

Conventionally, when manufacturing a gusseted pillow bag, a part integrating the spreader mechanism and the tube in a single piece was used in order to eliminate shifting of position between the spreader mechanism and the tube. In such a case, it was necessary to replace the entire tube in order to switch between manufacturing a pillow bag without gussets and a pillow bag with gussets. Thus, a problem had been presented in that excessive effort was required to reconfigure the machine.

Also, when manufacturing a gusseted pillow bag according to a conventional method, a configuration would be used wherein the spreader mechanism on the lower part of the tube was attached and detached with a pin or the like. In such a case, problem had been presented in that the driving of the gusset forming mechanism caused the spreader mechanism to shift position. A bag-making packaging machine also exists in which the fitting tolerance of the pin or the like is set at a high degree of precision in order to prevent position shifting from occurring. However, in such a case, the work of attaching and detaching the spreader mechanism was complicated.

In these modification examples, the configuration for attaching the spreader 139 to the tube 160 and detaching the spreader mechanism 139 from the tube 160 as described above allows the bag-making packaging machine 101 to be reconfigured with a simple operation. The attaching and detaching method described above also allows the spreader mechanism 139 to be precisely installed upon the tube 160. Thus, it is possible to form high-quality gussets G, G.

What is claimed is:

1. A bag-making packaging machine comprising:
a tube part, and
a forming collar including a fold-back portion defining a cutout, the forming collar being configured to receive a sheet-shaped packaging material that moves toward the forming collar in a first direction, the fold-back portion being configured and shaped to guide the sheet-shaped packaging material to move in a second direction perpendicular to the first direction such that the packaging material wraps around the tube part and continues to move along the tube part in the second direction, the cutout being provided along a surface of the fold-back portion such that a thick-layered portion of the sheet-shaped packaging material passes there along.

2. The bag-making packaging machine according to claim 1, wherein:
the thick-layered portion extends in the first direction in which the packaging material advances.

3. The bag-making packaging machine according to claim 2, wherein:
the thick-layered portion includes a hem seal region of the packaging material.

4. The bag-making packaging machine according to claim 3, wherein:
the cutout includes four cutouts formed in four spaced apart locations on the folded-back portion corresponding to four hem seal regions of the sheet-shaped packaging material.

5. The bag-making packaging machine according to claim 2, wherein:
the sheet-shaped packaging material has a main packaging material and a tape conveyed along with the main packaging material while overlapping therewith; and
the thick-layered portion is an area where the main packaging material and the tape overlap.

6. The bag-making packaging machine according to claim 5, wherein:
the cutout includes a single cutout formed on the folded-back portion so as to correspond to the overlapping portion.

7. The bag-making packaging machine according to claim 1, wherein:
the forming collar is positioned such that a gap is defined between the forming collar and the tube part, the sheet-shaped packaging material being directed into the gap by the fold-back portion; and
a first distance is defined between the forming collar and the tube part measured at the gap, and a second distance is defined between the forming collar and the tube part at the cutout the second distance being greater than the first distance.

8. The bag-making packaging machine according to claim 2, wherein:
the forming collar is positioned such that a gap is defined between the forming collar and the tube part, the sheet-shaped packaging material being directed into the gap by the fold-back portion; and
a first distance is defined between the forming collar and the tube part measured at the gap, and a second distance is defined between the forming collar and the tube part at the cutout the second distance being greater than the first distance.

9. The bag-making packaging machine according to claim 3, wherein:
the forming collar is positioned such that a gap is defined between the forming collar and the tube part, the sheet-shaped packaging material being directed into the gap by the fold-back portion; and
a first distance is defined between the forming collar and the tube part measured at the gap, and a second distance is defined between the forming collar and the tube part at the cutout the second distance being greater than the first distance.

10. The bag-making packaging machine according to claim 4, wherein:
the forming collar is positioned such that a gap is defined between the forming collar and the tube part, the sheet-shaped packaging material being directed into the gap by the fold-back portion; and
a first distance is defined between the forming collar and the tube part measured at the gap, and a second distance is defined between the forming collar and the tube part at the cutout the second distance being greater than the first distance.

11. The bag-making packaging machine according to claim 5, wherein:
the forming collar is positioned such that a gap is defined between the forming collar and the tube part, the sheet-shaped packaging material being directed into the gap by the fold-back portion; and
a first distance is defined between the forming collar and the tube part measured at the gap, and a second distance is defined between the forming collar and the tube part at the cutout the second distance being greater than the first distance.

12. The bag-making packaging machine according to claim 6, wherein:
the forming collar is positioned such that a gap is defined between the forming collar and the tube part, the sheet-shaped packaging material being directed into the gap by the fold-back portion; and
a first distance is defined between the forming collar and the tube part measured at the gap, and a second distance is defined between the forming collar and the tube part at the cutout the second distance being greater than the first distance.
